(19) United States
(12) Patent Application Publication
(10) Pub. No.: US 2021/0086296 A1
(43) Pub. Date: Mar. 25, 2021

(54) CUTTING MACHINE AND METHOD

(71) Applicant: BLACKMAN & WHITE CUTTING SOLUTIONS LIMITED, Maldon, Essex (GB)

(72) Inventor: Alexander Leslie WHITE, Maldon, Essex (GB)

(21) Appl. No.: 16/959,864

(22) PCT Filed: Dec. 21, 2018
(86) PCT No.: PCT/GB2018/053758

§ 371 Date: Jul. 2, 2020

(30) Foreign Application Priority Data
Jan. 3, 2018 (GB) 1800070.3

(51) Int. Cl. B23K 26/082; B23K 26/08; B23K 26/38; B23K 37/02; B41J 11/00; B41J 15/04; B41J 3/38

(52) U.S. Cl. CPC B23K 26/082; B23K 26/0838; B23K 26/38; B23K 2103/38; B41J 11/007; B41J 15/048; B41J 3/38; B23K 37/0235

(57) ABSTRACT

In a laser cutting machine for cutting a sheet of material, a laser scanner (12) is traversable in a lateral direction across a cutting surface (14). The laser scanner is controllable to direct a laser beam onto the cutting surface within a cutting area (A) of the cutting surface. A material-advancing mechanism is provided that is controllable to incrementally advance the sheet of material in a longitudinal direction over the cutting surface. In use, the material-advancing mechanism is controllable to position and hold stationary successive laterally- extending portions of the material in the cutting area. The laser scanner is controllable to cut each successive laterally-extending portion of the material held stationary in the cutting area before the material is advanced.

### FIELD OF THE INVENTION

The invention relates to a cutting machine and method. In particular, the invention relates to a cutting machine and method for cutting or embossing a sheet of material.

### BACKGROUND OF THE INVENTION

Lasers have been used to cut out shapes in sheets or webs of many materials, for example fabrics, paper products and metals. Laser cutting machines can also be used to emboss or mark sheets of material, by reducing the intensity of the laser beam so as not to penetrate through a sheet of material. In this document, the term cutting should be taken, where appropriate, to include embossing.

In a conventional laser cutting machine, a sheet of material for cutting is laid out on a cutting table. A laser is arranged to direct a laser beam downwardly onto the table to cut the sheet of material according to a desired cutting pattern. The laser is traversably mounted on a moveable gantry, which spans a width of the cutting table, and the gantry is movable in a direction parallel to the length of the table. The direction of motion of the gantry may be termed a longitudinal direction, and the direction of motion of the laser along the gantry may be termed a lateral direction. Controlling motion of the laser laterally along the gantry at the same time as controlling the motion of the gantry longitudinally along the table enables the material to be cut according to the pattern.

The cutting pattern may be defined by printing the pattern onto the sheet of material to be cut. The cutting machine then incorporates an optical reader, such as a camera, to read the printed pattern so that the motion of the laser can be appropriately controlled during cutting. One way to do this is for the laser to be controlled directly to follow a printed cutting pattern. Alternatively, the cutting pattern may not be printed on the material, but may be defined by a computer data file for controlling the laser cutting machine. In such cases, if the material for cutting has been printed, for example with printed images that are to appear on portions of material cut by the cutting machine, it is important that the pattern cut by the cutting machine is in register with, or is aligned with, the printed images. To achieve this, the printer conventionally prints registration marks on the material. The optical reader then scans the material and locates the registration marks, so that the cutting machine can apply the cutting pattern in register with the printed images.

One problem with a conventional laser cutting machine is its slow speed of operation. It takes time to load a sheet of material onto the cutting table, and then the cutting speed of the machine is limited by the speed of the laser moving along the gantry and the speed of the gantry moving parallel to the length of the table. The mass of the gantry in particular may be large and so it is difficult to move quickly.

In recent times, the slow speed of operation of conventional cutting machines has become more of a problem as the speed of printers, for printing cutting patterns, or images, onto sheets of material for cutting, is increasing due to technical development of the printers. In a manufacturing plant, a conventional cutting machine of the type described above used to operate sufficiently fast to cut the sheets of material output from one or more printers. Today, this type of cutting machine cannot keep pace with the output from even a single printer. In a production process, the rate-determining step is therefore the cutting.

Another disadvantage of a conventional laser cutting machine is that it takes up a large area of floor space. The size of the machine is defined by the size of the sheet of material to be cut, and therefore by the size of the cutting table. For example, a typical cutting machine may have a cutting table that is 3 metres by 4 metres. Extra space must also be available for mounting the gantry outside the cutting surface, and an operating distance of about 1 m must be left around all sides of the cutting machine for the safety of operators of the machine. As space in factories and workshops becomes more expensive, it is becoming less tenable to have such large laser cutting machines.

WO 94/23886 describes one approach to making a smaller cutting machine. In this machine, a laser beam is directed onto a cutting table by a mirror, for reflecting a laser beam from a fixed laser, which is traversable along a fixed gantry. The position of the laser beam on the cutting table can therefore be moved across the cutting surface in a lateral direction parallel to the gantry. At the same time, a sheet of fabric for cutting is held on two rolls, one on either side of the cutting surface, which form a bidirectional material feed means. The sheet of material is movable, beneath the gantry, backwards and forwards between the rolls so that by synchronising the bidirectional movement of the material in a longitudinal direction, and the movement of the laser beam in a lateral dimension, the material can be cut according to a desired cutting pattern. Although this approach may avoid the need for a large cutting table and a movable gantry, the requirement to move the material backwards and forwards across the cutting surface is a significant disadvantage, as it leads to very inaccurate positioning of the material for cutting and therefore to inaccurate cutting. This can be a particularly significant problem, for example, for materials such as fabrics which can stretch and deform as they are fed backwards and forwards between the rolls. This problem becomes still greater during the cutting of the material, as cuts in the material weaken it and cause additional distortion and inaccuracy.

It would therefore be highly advantageous to have a laser cutting machine which occupies a reduced amount of space in a manufacturing plant, cuts accurately and cuts at a speed which is at least the same speed as a printing machine.

### SUMMARY OF THE INVENTION

The invention provides a laser cutting machine for cutting a sheet of material and a method for cutting a sheet of material as defined in the appended independent claims, to which reference should now be made. Preferred or advantageous features of the invention are set out in dependent sub-claims.

In a first aspect, the invention may thus advantageously provide a laser cutting machine as follows. A laser scanning unit, or laser scanner, is traversable in a lateral direction across a cutting surface and is controllable to direct a laser beam onto the cutting surface within a cutting area of the cutting surface. The laser beam may be generated by a fixed laser, or laser source, and reflected by the laser scanner onto the cutting surface, and the laser scanner may be moveably mounted on a fixed gantry or other support. The laser scanner is preferably controllable to deflect the laser beam in both lateral and longitudinal directions across the cutting surface, within a scanning area beneath the laser scanner, so that the combination of the deflection of the laser beam by the laser scanner and the lateral traversing of the laser scanner defines the cutting area, or cutting window, on the cutting surface. A material-advancing mechanism, which may comprise a conveyor belt, is controllable to advance the sheet of material incrementally, or stepwise, in a longitudinal direction over the cutting surface. In use, the material-advancing mechanism is controllable, for example by a programmable controller, to position and hold stationary in the cutting area successive laterally-extending portions of the material. The laser scanner is controllable, for example by the programmable controller, to cut each successive laterally-extending portion of the material while it is held stationary in the cutting area before the material is advanced again. After a laterally-extending portion of the material has been cut, the material may be advanced so that the next successive laterally-extending portion of the material is stationary in the cutting area and can be cut.

In this document, the term “laterally” refers to a direction across the width of the sheet of material, from one edge of the sheet to the other. This may be termed the x-axis direction. The term “longitudinally” refers to a direction extending along the length of the sheet, preferably parallel to the direction of incremental advance of the sheet. This may be termed the y-axis direction. The lateral direction is preferably, but not necessarily, perpendicular to the longitudinal direction. The cutting area may thus have a rectangular shape which has a longer lateral dimension and a shorter longitudinal dimension, for example in the shape of a letterbox. The dimension of the cutting area in the lateral direction, parallel to the traversing direction of the laser scanner, may be more than 5, or 10, or 15 times as long as the dimension of the cutting area in the longitudinal direction, and is preferably less than 50 or 40 times as long as the dimension of the cutting area in the longitudinal direction.

In a preferred embodiment, the laser scanner may thus be controllable to move the position of the laser beam on the cutting surface within a smaller rectangular or square scanning area, having a dimension in the longitudinal direction that is equal to the dimension of the cutting area in the longitudinal direction. The limits of the traversing movement of the laser scanner in the lateral direction then define the dimension of the cutting area in the lateral direction.

The laser scanning unit, or laser scanner, is advantageously lighter and can be moved more rapidly than a laser source, Traversing the laser scanner along a fixed gantry may therefore enable faster, more accurate, cutting of the sheet of material, compared to moving a laser source on a fixed or moveable gantry. In an alternative embodiment of the invention, however, the laser could be movably mounted on the gantry as long as the functionality of the laser scanner is retained, to allow the position of the laser beam on the cutting surface to be moved laterally and longitudinally within the cutting area.

A laser cutting machine embodying the invention may advantageously be smaller than, and in particular take up less floor space than, a conventional laser cutting machine because the gantry is fixed and the sheet of material is incrementally advanced through the laser cutting machine. Having a fixed gantry means that a mechanism to enable movement of the gantry is not required and so a lateral dimension of the laser cutting machine may be smaller than that of a conventional cutting machine able to cut the same width of material but having a movable gantry. Also, as the sheet of material is advanced through the laser cutting machine, for example beneath the gantry, the cutting surface of the laser cutting machine does not need to be as long as the length of the sheet of material and a longitudinal dimension of the laser cutting machine is significantly reduced.

In a preferred aspect of the invention, the material-advancing mechanism moves the sheet of material incrementally, or step-wise, so that each successive laterally-extending portion of the material is held stationary in the cutting area for cutting. Because the sheet of material is held stationary during cutting, the accuracy of cutting may be optimised; the inventors have found that cutting accuracy is advantageously at least as accurate as for a conventional cutting machine in which the entire sheet of material is placed on a cutting table and is cut by a laser traversing both laterally and longitudinally across the cutting table.

Moving the sheet of the material incrementally, and in only one direction, may advantageously allow cut or embossed material to be removed from the laser cutting machine in a controlled manner after cutting. This is a significant advantage over systems such as in WO 94/23886 which require bidirectional movement of the material.

In embodiments of the invention a desired cutting pattern is likely to be larger than the cutting area, particularly in the longitudinal direction, and it is important to ensure that the entire cutting pattern may be cut. To achieve this, the cuts made in successive laterally-extending portions of the sheet of material need to meet or be in register with each other, and preferably to overlap to compensate for any variability or tolerances in the distance through which the sheet is moved by the material-advancing mechanism at each incremental advance. Thus, the distance through which the sheet is moved in each incremental advance is equal to, or is preferably less than, a longitudinal dimension of the cutting area. The incremental-advance distance may for example be less than 99% or 98% or 95%, and/or more than 85% or 90% or 93%, of the longitudinal dimension of the cutting area. The larger the incremental-advance distance, the larger the area of material that can be cut at each increment, and so the faster the machine can cut a sheet of material (because fewer cutting cycles are required).

The laterally-extending portions of the sheet of material may be considered as areas of the material having approximately the same shape as the cutting area.

A cutting pattern or other printed matter may be printed onto the sheet of material before cutting. The laser cutting machine may then advantageously comprise a reader, such as an optical reader or camera, for reading the printed cutting pattern or other printed matter.

Preferably, the reader is coupled to the laser scanning unit, or laser scanner, so that as the laser scanner traverses along the gantry, the reader traverses at the same time and can read the cutting pattern or other printed matter on the sheet of material within a reading area of the sheet of material. The reading area may advantageously have the same dimensions as the cutting area, so that a data file representing an output of the reader can be used to control the laser scanner to cut the same laterally-extending portion of the sheet of material.

In one embodiment, if a cutting pattern is printed on the sheet of material, the output of the reader may be a representation of the printed cutting pattern within each reading area, which can then be used to control the laser scanner by following the printed cutting pattern, when that portion of the sheet of material is in the cutting area.

In an alternative embodiment, the cutting machine may previously have received, or be programmed with, the desired cutting pattern, and may only need to ensure that the cutting pattern is applied in register with printed matter on the material.

As in the prior art, this may be achieved by using registration marks printed onto the sheet of material, so that the cutting machine can apply the cutting pattern in register with the registration marks. In embodiments of the invention, however, at any one time the optical reader can only read a laterally-extending portion of the sheet of material that falls within the reading area. In a conventionally-printed sheet of material the registration marks are generally spaced much further apart than the longitudinal dimension of the reading area, so that for many incremental positions of the sheet of material, no registration mark will fall within the reading area. A cutting machine embodying the invention may address this problem by reading registration marks when a registration mark does fall within the reading area, and interpolating between these registration marks in cutting areas which correspond to portions of the sheet of material where no registration marks appear in the reading area. This approach may reduce cutting accuracy (particularly if the material is elastic, or deformable, so that it may be difficult to advance the material accurately) but may be sufficient for cutting operations where such loss in cutting accuracy is acceptable. However, in a preferred embodiment of the invention the problem may be addressed by printing registration marks on the sheet of material more closely-spaced than is conventional, preferably so that at least one registration mark is present in each reading area, as the sheet of material is incrementally advanced.

In a further preferred embodiment of the invention, an alternative approach may be used. For instance it may be desired to cut a large rectangle surrounding a printed image, such as a poster, printed on the sheet of material for cutting. A program or data file previously provided to the cutting machine may define the size of the finished cut rectangle and the printed contents of the rectangle (e.g. the printed image). As the sheet of material advances through the cutting machine, the optical reader may scan the reading area and recognise a first printed part of the poster. At this point, when that portion of the sheet of material is in the cutting area, the laser would cut the first portion of the rectangle around the printed poster. The poster may be much larger than the dimension of the cutting area in the longitudinal direction, and so cutting the outline of the poster may require multiple reading and cutting cycles, or scans, of the cutting machine. The cutting machine would therefore cut the outline of the poster, scan by scan, until complete. The same process may be used for cutting any shape including the complex patterns required for garments such as printed sportswear for cyclists or other complex cutting patterns.

The reading area is preferably adjacent to the cutting area, so that the reader reads the cutting pattern (or registration marks, or printed image) printed on a portion of the sheet of material that will, after incremental advance by the material-advancing mechanism, be cut by the laser. Preferably, the reader reads the laterally-extending portion of the sheet of material immediately upstream from the portion of material being cut at that time.

This may maximise cutting speed, as only a single traverse of the laser scanner is required during each cutting step, because reading and cutting operations are performed at the same time. Also, there is time (while the material is incrementally advanced) for any processing of the output of the reader that may be required to generate a control signal for subsequently controlling the laser scanner.

Advantageously, the reading area may be positioned at least partially within the cutting area, for example partially overlapping the cutting area. This may allow the reader more accurately to enable control of the cutting of the material in successive laterally-extending portions of the material, to connect the pattern cut in successive laterally-extending portions of the material. In this case, the reading area may advantageously be larger than the cutting area, in the longitudinal direction.

Alternatively, the reading area may be the same as the cutting area. In this case, the size of the cutting machine may be minimised, but it is necessary for the machine to read the pattern (or registration marks, or printed image) and to cut the pattern in the same area while the material is held stationary. This may be done either by reading the pattern during a first traverse of the laser scanner/reader, and then cutting the material in a second traverse, or by reading the pattern immediately ahead of the traversing laser scanner so that the material can immediately be cut. In the first of these options, two traverses are required while each laterally-extending portion of the material is held stationary in the cutting area, which may slow down the cutting process. In the second of these options, any time taken to process the output from the reader may slow the cutting process, by requiring a slower traversing speed. However, there may be an advantage in cutting accuracy if reading and cutting both occur without incrementally advancing the material between reading and cutting. This may be a particular advantage if the material is elastic, or deformable.

Embodiments of the invention may employ different methods for controlling the traversing of the laser scanner and, if present, the reader. For example, all traversing motion during cutting and/or reading may be in the same direction, with a rapid traverse in the opposite direction after a cutting and/or reading cycle, in the manner of a raster scan. Alternatively, cutting and/or reading may be performed during traversing in both directions, in the manner of a boustrophedonic scan.

Alternatively, cutting and reading need not be performed at the same time, and may for example be performed during traversing in opposite directions. This may be an advantage if the reading area and the cutting area are the same; after a portion of material has been incrementally advanced into the cutting area, that area may be read by the reader traversing in one direction and then cut by the laser scanner traversing in the opposite direction. Such an approach may allow faster operation of the cutting machine by eliminating the rapid “flyback” portion of the traverse, or scanning, of the laser scanner and reader.

If the reading area and the cutting area do not coincide, so that the reader reads a portion of the material upstream of the cutting area, then reading may be performed at the same time as cutting, during the same traverse of the laser scanner and reader. In that case, the laser scanner and reader may be traversed rapidly back for a subsequent cutting/reading traverse in the same direction, while the material is being incrementally advanced. Or the subsequent cutting and reading operation may be performed during a traverse in the opposite direction.

Preferably, the material-advancing mechanism comprises a conveyor belt. The conveyor belt may comprise a vacuum system to draw the sheet of material onto the conveyor belt.

Preferably, the conveyor belt comprises a metal mesh. The open structure of the metal mesh may then allow the air to be easily drawn through the conveyor belt by a vacuum pump, to produce even suction over the cutting surface.

Preferably, the cutting area is within an area of the sheet of material supported by the conveyor belt to ensure that the material is accurately held stationary during cutting.

Preferably, if the cutting apparatus comprises a reader for reading a printed cutting pattern, both the cutting area and the reading area are within an area of the sheet of material supported by the conveyor belt. Particularly preferably, if the reading area is at a portion of the sheet of material that is upstream of the cutting area, this may ensure that as the material is incrementally advanced from the reading area to the cutting area, the positioning of the material is accurately retained. This may be advantageous because any unexpected movement or deformation of the material between the reading area and the cutting area may lead to loss of cutting accuracy.

In a preferred embodiment, the reading area may thus be directly adjacent to the cutting area, and the sheet of material in both the reading area and the cutting area securely supported and held by, for example, a vacuum system applied to a conveyor belt which extends across both the reading area and the cutting area. As the conveyor belt incrementally advances the material from the reading area to the cutting area, the movement of the material is therefore fully under control and there is no unexpected movement of the material.

In a cutting machine embodying the invention, the laser scanning unit (laser scanner) may be controllable to move the laser beam within a two-dimensional scanning area, which traverses laterally along elongated cutting area as the laser scanner traverses during cutting. The movement of the laser beam within the scanning area may be very rapid, and may be much faster than a traversing speed of the laser scanner. Therefore, in a preferred embodiment of the invention the vacuum system may comprise a vacuum plenum which traverses with the traversing laser scanner and which applies a vacuum only to the portion of the sheet of material within the scanning area. The vacuum plenum applies the vacuum to a vacuum area defined by the size of the vacuum plenum, which is large enough to include the scanning area and may be the same size and shape as the scanning area. The rapid movement of the laser beam within the scanning area therefore always falls within the vacuum area.

This approach may advantageously reduce the power required to apply the vacuum to hold the sheet of material securely during cutting, by holding the sheet of material only in the area being cut at any time.

The vacuum plenum may be used in combination with the larger vacuum chamber described above, for holding the sheet of material in the entire cutting area and/or the reading area, or the vacuum plenum may be used by itself, in embodiments which do not incorporate a larger vacuum chamber.

The use of a vacuum plenum covering only the scanning area may additionally provide a fume extraction function, covering only the scanning area during cutting. A corresponding gas hood may be provided above the sheet of material, between the sheet of material and the laser scanner, for the supply of a suitable flow of air to the cutting area, and for fume extraction.

As the laser cutting machine may advantageously cut at at least the same speed as a printer, the printed sheet of material may be passed from a printer directly to the laser cutting machine for cutting. In such an arrangement, the printer may advantageously comprise a material-advancing mechanism for advancing the sheet of material through the same incremental advance distance as the laser cutting machine. Alternatively, the same material-advancing mechanism may advance the sheet of material through the printer and the laser cutting machine.

In this aspect of the invention, a data file used by the printing machine to control the printing operation may also be used by the cutting machine to control cutting of the same sheet of material. Typically, the resolution required for controlling cutting may be significantly lower than the resolution required for printing, and so a version of the data file for controlling the cutting machine may advantageously have lower resolution, and therefore be of smaller file size, than the data file for controlling printing.

A further aspect of the invention may advantageously provide a method for cutting a sheet of material. In the method, a first step may thus comprise incrementally advancing the sheet of material in a longitudinal direction such that successive laterally-extending portions of the sheet of material are positioned and held stationary at a predetermined cutting position within a laterally-extending cutting area. A second step may then comprise traversing a laser scanning unit, or laser scanner, in a lateral direction to cut each laterally-extending portion of the material, while held stationary, by controlling the laser scanner to direct a laser beam within the cutting area in accordance with a cutting pattern. These steps can then be repeated to cut each successive laterally-extending portion of the material and, after repeated cutting steps, to cut the entire sheet of material according to a desired cutting pattern.

Preferably, the method may further comprise a step of reading a cutting pattern or other printed matter printed onto the sheet of material, for example by means of a reader coupled to the laser scanner, which may read a portion of the cutting pattern or other printed material printed on the laterally-extending portion of the sheet of material held stationary in the predetermined cutting position, or may read a portion of the cutting pattern or other printed material printed on a the material adjacent to or upstream of the material held stationary in the predetermined cutting position.

### DESCRIPTION OF SPECIFIC EMBODIMENTS AND BEST MODE OF THE INVENTION

Embodiments of the invention will now be described by way of example, with reference to the accompanying drawings in which:

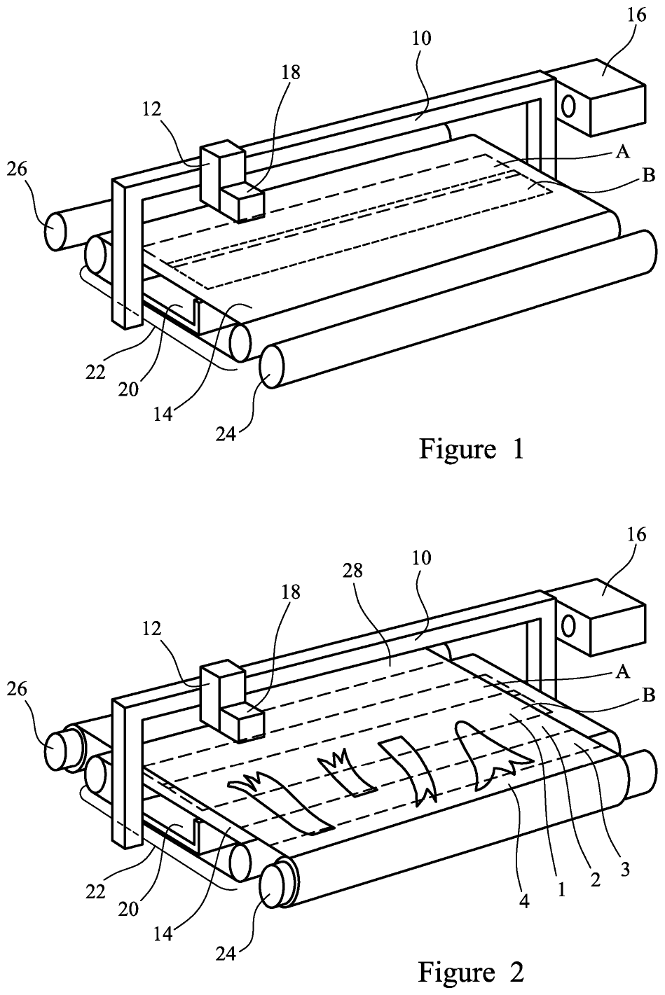

FIG. 1 is a perspective view of a laser cutting machine according to a first embodiment of the invention;

FIG. 2 is a perspective view of the laser cutting machine of FIG. 1 illustrating the movement of a sheet of material through the laser cutting machine;

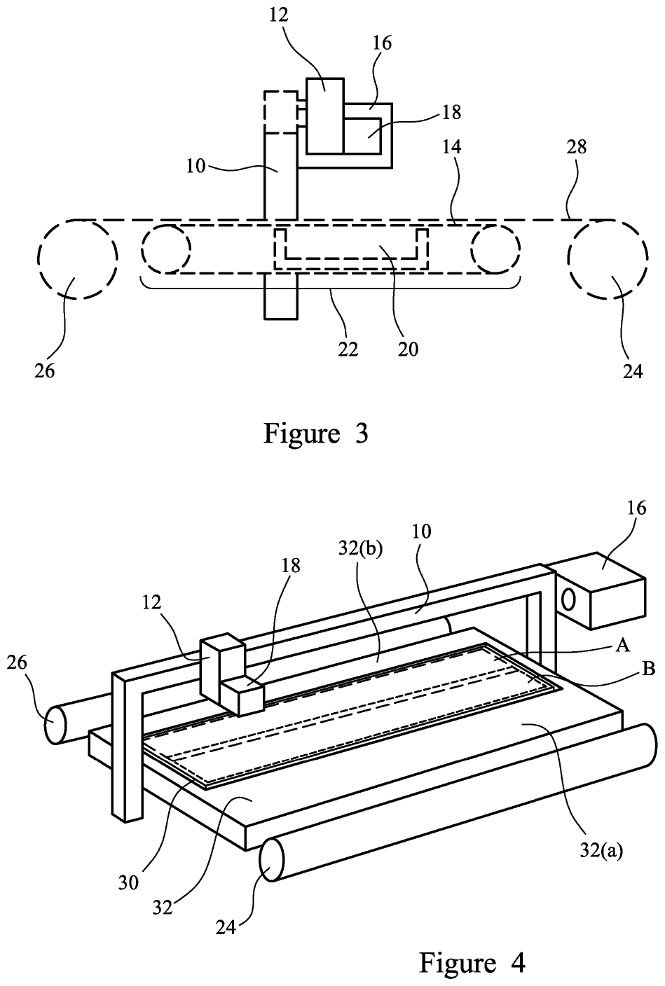

FIG. 3 is a cross section of the laser cutting machine according to the first embodiment of the invention;

FIG. 4 is a perspective view of a laser cutting machine according to a second embodiment of the invention;

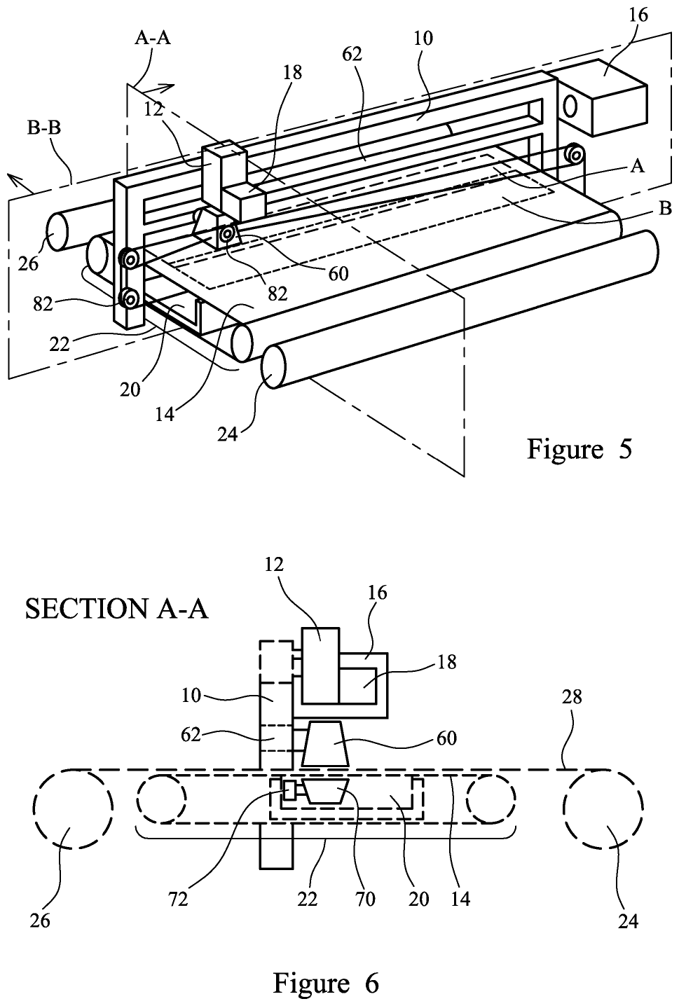

FIG. 5 is a perspective view of a laser cutting machine according to a third embodiment of the invention;

FIG. 6 is a longitudinal section of the laser cutting machine of FIG. 5, on A-A;

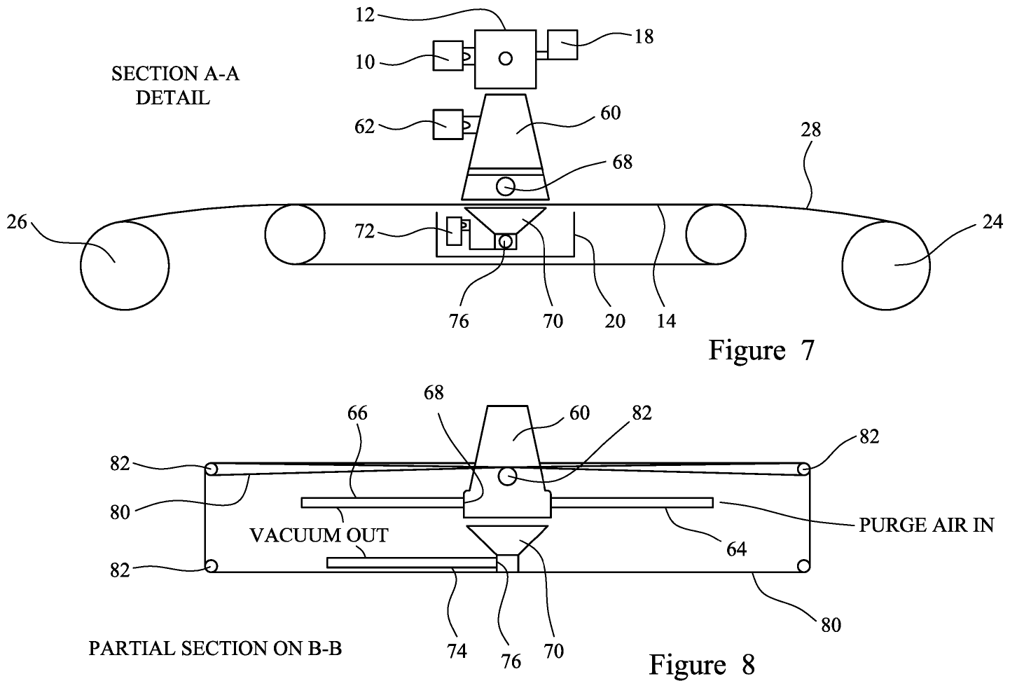

FIG. 7 is a more detailed longitudinal section of the laser cutting machine of FIG. 5, on A-A;

FIG. 8 is a lateral section showing part of the laser cutting machine of FIG. 5, on B-B, namely the purge and vacuum system in the scanning area; and

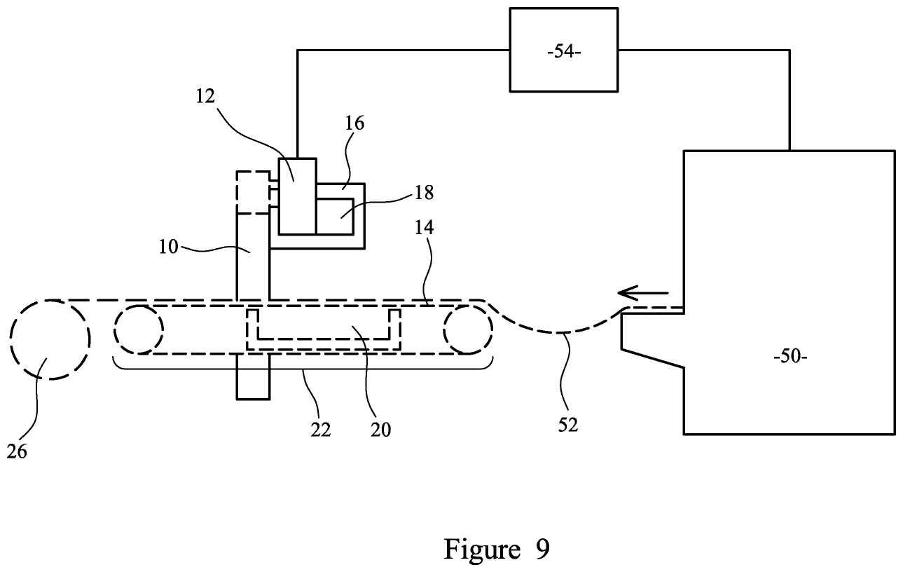

FIG. 9 is a schematic diagram of a further embodiment of the invention, in which a laser cutting machine is integrated with a printing machine, or printer.

A laser cutting machine according to a first embodiment of the invention is shown in FIG. 1. It comprises a fixed support or gantry 10 on which a laser scanner 12 is traversably mounted. Beneath the gantry is a cutting surface 14 which comprises a metal mesh conveyor belt 22 for carrying a sheet of material for cutting. The traversably-mounted laser scanner is controllable to direct a laser beam from a fixed laser source 16 onto the cutting surface 14 within a cutting area A.

The laser scanner 12 is traversable in a lateral direction along the fixed gantry and is controllable to steer, or direct the laser beam in both lateral and longitudinal directions within a scanning area beneath the laser scanner. Lateral and longitudinal deflection of the laser beam by the laser scanner, in combination with the traversing of the laser scanner along the gantry, defines a long, thin rectangular cutting area A on the cutting surface 14.

The laser cutting machine of FIG. 1 also comprises a reader 18, which is fixed to and traversable with the laser scanner 12. The reader, which is an optical reader, or camera, therefore traverses in a lateral direction, parallel to the gantry 10. The reader is arranged to read within a reading area B of the cutting surface 14. In FIG. 1, the reading area B is the same size and shape as the cutting area A, and adjacent to and upstream from the cutting area A. The reading area partially overlaps the cutting area. In FIG. 1 the reading area B is demarcated by short dashed lines and the cutting area A is demarcated by long dashed lines.

The metal mesh conveyor belt 22 extends across the cutting area A and the reading area B for transporting a sheet of material, such as fabric, for reading and cutting. The top surface of the conveyor belt forms the cutting surface 14. Within the conveyor belt 22 and beneath the reading area B and the cutting area A of the cutting surface 14, a U-shaped channel 20 extends in a lateral direction and defines a vacuum chamber. A vacuum applied to the vacuum chamber can draw the sheet of fabric onto the conveyor belt across the entire areas of both the reading area B and the cutting area A.

The printed fabric (or other sheet material) is advanced through the laser cutting machine by the conveyor belt 22 which draws the fabric from a feed roller 24. Cut fabric is collected on a collection roller 26.

FIG. 2 shows the laser cutting machine of FIG. 1 with a roll of printed fabric 28 laid across the cutting surface. Virtual dotted lines on the fabric 28 (not printed on the fabric) show successive strips of fabric that will be read, incrementally advanced and then cut by the laser cutting machine. The reader 18 can read a cutting pattern printed on the roll of fabric 28. The cutting pattern can extend over several strips or increments. For example, in FIG. 2, the printed cutting pattern extends over 4 strips.

The conveyor belt 22 is controllable by a programmable controller (not shown), to position and hold stationary in the cutting area successive strips of the material. The reader is controllable by a programmable controller (not shown) to read a cutting pattern printed on a strip of the material while it is held stationary in the reading area before the material is advanced. A memory (not shown) stores the read cutting pattern of the strip of material that has been read by the reader. The laser scanner is controllable by a programmable controller (not shown), to cut each strip of the material, according to the cutting pattern printed on the strip of material while it is held stationary in the cutting area before the material is advanced. After a strip of the material has been cut, the material is advanced so that the next strip of the material is stationary in the cutting area and can be cut.

Although the embodiment is described with reference to controlling the cutting machine by reading and following a cutting pattern printed on the fabric, alternative approaches may be used as described above. These may include reading registration marks printed on the fabric and cutting a predetermined pattern aligned with the registration marks, or programming the cutting machine to cut predetermined patterns in register with printed images, for example to cut desired outlines around printed images.

When the printed sheet of material for cutting is placed on the cutting surface 14, the sheet of material is advanced to the position shown in FIG. 2 in which a first strip 1 of the material is held stationary in the reading area B and the printed cutting pattern in a the first strip 1 of the sheet of material is read. The reader stores the read printed cutting pattern (and/or the location of registration marks or printed images) in the first strip 1 in a data file in the memory. The sheet of material is then advanced, such that the first strip 1 of the sheet of material is held stationary in the cutting area A. The first strip 1 of the sheet of material is then cut in accordance with the read cutting pattern of the first strip 1, using the information on the first strip 1 stored by the reader in the data file. At the same time as the first strip 1 of the sheet of material is cut in cutting area A, a second strip 2 of the sheet of material is read in the reading area B by the reader traversing in unison with the laser scanner. After the first strip 1 has been cut in the cutting area A and the second strip 2 has been read in the reading area B, the conveyor belt advances the sheet of material, such that the second strip 2 is held stationary for cutting in cutting area A and a third strip 3 is held stationary for reading in the reading area B. The conveyor belt continues to incrementally advance the printed sheet of material through the laser cutting machine, in this manner.

When the material to be cut is on the conveyor belt, the vacuum 20 draws the material onto the conveyor belt over both the reading area B and the cutting area A. There is even suction from the vacuum across these two areas. The vacuum continues to draw the material onto the conveyor belt during reading of the material in the reading area, advancement of the material, and cutting of the material in the cutting area.

The distance through which the material moves in each incremental advancement is less than the width of the cutting area to ensure that all portions of the material can be cut. The width of each strip of material is equal to the distance through which the material moves in each incremental advancement.

In the laser cutting machine according to the first embodiment of the invention shown in FIGS. 1 and 2, the cutting of a strip of material in cutting area A is performed at the same time as the reading of an adjacent strip of material in cutting area B because the reader is moveable with the laser scanner which traverses along the gantry. In FIG. 1, the reader is positioned to read within the reading area B which is adjacent to or slightly overlapping the cutting area A. However, the reader could read a strip of material any distance ahead of the cutting area, or overlapping the cutting area. Preferably, the reading area B and the cutting area A have a sufficient degree of overlap such that each strip of material is centred in, and falls entirely within, the reading area when the strip of material is being read, and within the cutting area when it is being cut.

FIG. 3 shows a cross section of the cutting machine of FIG. 2. The material to be cut is provided on a feed roller 24, and is transported through the laser cutting machine by the conveyor belt 22. The material to be cut is drawn onto the conveyor belt by the vacuum 20 which is positioned below both the reading area and the cutting area. Once cut, the material is collected on a collection roller 26.

A laser cutting machine according to a second embodiment of the invention is shown in FIG. 4. The arrangement of the fixed gantry 10, laser scanner 12, reader 18 and laser source 16 is the same as described in relation to the first embodiment shown in FIGS. 1, 2, and 3. Beneath the gantry is a cutting table 32 which comprises a short conveyor belt 30 positioned within an opening in the cutting table. The short conveyor belt 30 covers the cutting area A and the reading area B and has a vacuum chamber (not shown) extending across both the cutting area A and the reading area B.

A material to be cut is provided on the feed roller 24. The material may be considered as being divided into virtual, successive, laterally-extending portions that will be read, advanced and then cut, as described in relation to FIG. 2. When the material to be cut is positioned on the cutting table 32, the material is incrementally advanced by the conveyor belt 30. The conveyor belt is controllable by a programmable controller (not shown), to position and hold stationary in the cutting area successive strips of the material. As the material is advanced by the conveyor belt according to the second embodiment of the invention, it is drawn from the feed roller 24, over a first stationary part of the cutting table 32(a) and onto the conveyor belt 30. The material is drawn onto the conveyor belt by a vacuum (not shown) which extends under the width of the top surface of the conveyor belt. The vacuum holds down the material whilst a printed cutting pattern on a strip of the material to be cut is read by the reader in the reading area B, incrementally advanced by the conveyor belt and then cut by the laser scanner in the cutting area A. The conveyor belt can therefore be the same size as the reading area B and the cutting area A. Once the same strip of the material is cut, the conveyor belt transports the cut strip of material such that it comes off the conveyor belt onto a second stationary part of the cutting table 32(b), where it can be collected on the collection roller 26.

In FIGS. 1 to 4, the reader is fixed upstream of the laser scanner to read within the reading area B which is adjacent to, and slightly overlapping the cutting area A. In an alternative embodiment of the invention (not shown), the reader is fixed alongside the laser scanner such that the reading area is the same as, or contains, the cutting area A. This could then operate by reading the printed pattern in a strip in a first traverse of the laser scanner/reader and then cutting the same strip, without advancing the material, in a second traverse of the laser scanner/reader. Alternatively, the printed pattern in the strip may be read immediately ahead of the traversing laser scanner so that the material can be cut immediately after reading, in a single traverse.

In a further embodiment of the invention, illustrated in FIG. 9, the laser cutting machine of FIGS. 1 to 4 is combined with a printer 50. The printed material 52 may exit directly from the printer, in the direction of the arrow in the Figure, onto the conveyor belt of the laser cutting machine to be read and then cut. The cutting machine and the printer may be controlled by a common programmable controller 54. Modern printers typically advance sheets of material incrementally. It is therefore possible to synchronise and match the rates of the incremental advancement of the fabric exiting the printer with the incremental advancement of the conveyor belt of the laser cutting machine. A desired quantity of slack material, as shown at 52 in FIG. 9, may be provided to accommodate any intermittent differences in the material feed rates of the printer and the cutting machine, and appropriate feedback provided to ensure that the feed rates remain synchronised.

In one embodiment, the printer and the cutting machine may advance the material in different incremental distances. In such cases, the frequency with which the material is incrementally advanced by each machine may be adjusted to produce the same average rate of material advance.

In addition, in preferred embodiments, the same data files, or versions of the same data files having different resolutions or different colour information, may be used to control the printer and the cutting machine. The cutting machine may require data files with lower resolution than the printer, and with no colour information unless the reader of the cutting machine requires colour information in order to recognise images or patterns printed by the printer.

FIGS. 5 to 8 illustrate a third embodiment of a cutting machine embodying the invention. In the third embodiment, all of the structure of the first embodiment, of FIGS. 1 to 3, is retained and the same reference numerals are used in FIGS. 5 to 8. In the third embodiment, an additional purge gas and vacuum system is added to the first embodiment.

The purge gas and vacuum system comprises a purge gas hood 60 positioned below the laser scanner 12 and above the fabric, or sheet of material, 14. The hood is traversably mounted on a support beam 62 of the gantry 10, for movement parallel to the traversing movement of the laser scanner. A flexible air-supply tube 64 feeds air to an inlet of the hood during cutting, to ensure that the laser cuts the fabric cleanly. A flexible vacuum tube 66 is coupled to a vacuum pump (not shown) and withdraws air, and fumes from the laser cutting, from an outlet 68 of the hood.

The purge gas and vacuum system further comprises a vacuum plenum 70 arranged below the conveyor belt 14, within the vacuum chamber 20. The plenum is traversably mounted on a support beam 72 extending within the vacuum chamber, for movement parallel to the traversing movement of the laser scanner, A flexible vacuum tube 74 is coupled to a vacuum pump (not shown) and withdraws air (and any fumes) from an outlet 76 of the vacuum plenum.

The hood has a downwardly-facing opening, surrounding a scanning area in which the laser scanner can control the movement of the laser beam during cutting. The plenum has an upwardly-facing opening covering substantially the same area as the opening of the hood. The conveyor belt and the fabric, or sheet of material, carried by the conveyor belt pass between the downwardly-facing opening of the hood and the upwardly-facing opening of the plenum.

The vacuum applied to the plenum may be stronger than the vacuum applied to the hood, so that the vacuum applied by the plenum draws the fabric into contact with the conveyor belt, and holds it there during cutting.

The hood and the plenum are linked by a cable 80 passing around pulleys 82 so that the hood and the plenum always move together, and the hood remains above the plenum at all times. Movement of the hood and the plenum can then be controlled by a drive mechanism so that the hood remains below and aligned with the laser scanner at all times as the laser scanner traverses, and the plenum remains below the hood.

The vacuum applied to the hood and the plenum advantageously withdraws any fumes generated by laser cutting. The localisation of the hood and the plenum in the scanning area advantageously minimises the volume of fume-laden air withdrawn during cutting, which simplifies the filtering and cleaning of the air.

In the embodiment, a vacuum is additionally applied to the vacuum chamber 20 to hold the fabric (or other material) in contact with the conveyor belt across the entire cutting area and reading area. This may advantageously optimise the accuracy with which the conveyor belt advances the fabric and holds it during reading and cutting. However, in alternative embodiments it may be possible to reduce the size of the vacuum chamber. This may be desirable in order to reduce the volume of air to be drawn through the vacuum system, and therefore to reduce the energy consumption of the cutting machine. It may even be possible to or even to eliminate the vacuum chamber completely.

One such modification may be applied to any of the embodiments of the invention described herein. In this modification, in which the traversable hood and/or vacuum plenum may or may not be present, the size of the vacuum chamber is reduced so that it extends only to cover the cutting area of the cutting machine, and not the reading area. This approximately halves the area of fabric to which the vacuum is applied, and may correspondingly halve the flow rate of air required to maintain the vacuum, and so approximately halve the energy consumption. This may be appropriate as long as any loss in accuracy of positioning the fabric is acceptable. For example, this may be acceptable unless the fabric is deformable or elastic.

An alternative modification may be applied to the third embodiment described herein, and illustrated in FIGS. 5 to 8. In this modification, the vacuum chamber may be removed completely. The hood and the vacuum plenum in the scanning area are retained, and only the vacuum applied to the vacuum plenum is used to hold the fabric in contact with the conveyor belt. This may involve a loss in accuracy in the advancement of the fabric into the reading area and from the reading area to the cutting area, but may advantageously ensure that the fabric is securely held in the scanning area as it is being cut. This may be acceptable for fabrics or other materials that are not deformable or elastic, or which can otherwise be advanced accurately.

1. A laser cutting machine for cutting a sheet of material, comprising:
a laser scanner traversable in a lateral direction across a cutting surface and controllable to direct a laser beam onto the cutting surface within a cutting area of the cutting surface; and
a material-advancing mechanism controllable to incrementally advance the sheet of material in a longitudinal direction over the cutting surface;
in which, in use, the material-advancing mechanism is controllable to position and hold stationary successive laterally-extending portions of the material in the cutting area and the laser scanner is controllable to cut each successive laterally-extending portion of the material held stationary in the cutting area before the material is advanced.

2. A laser cutting machine according to claim 1, wherein the cutting area is defined by a traversing direction of the laser scanner and by the laser scanner deflecting the laser beam laterally and longitudinally within the cutting area.

3. A laser cutting machine according to claim 1, wherein the material-advancing mechanism is controllable to incrementally advance the sheet of material, for cutting successive laterally-extending portions, through a distance less than a dimension of the cutting area in the longitudinal direction.

4. A laser cutting machine according to claim 1, controllable to cut the sheet of material according to a predetermined cutting pattern, wherein a dimension of the cutting pattern in the longitudinal direction is greater than a dimension of the cutting area in the longitudinal direction.

5. A laser cutting machine according to claim 1, comprising a reader for reading printed-matter printed onto the sheet of material, in which the printed matter is preferably selected from a printed cutting pattern, a registration mark or a printed image.

6. A laser cutting machine according to claim 5, wherein the reader is coupled to the laser scanner and is arranged to read a portion of the printed matter within a laterally-extending reading area.

7. A laser cutting machine according to claim 6, wherein the reading area is adjacent to the cutting area.

8. A laser cutting machine according to claim 6, wherein the reading area is positioned at least partially within the cutting area.

9. A laser cutting machine according to claim 6, wherein the reading area is the same as the cutting area.

10. A laser cutting machine according to claim 1, wherein the material advancing mechanism comprises a conveyor belt and wherein the cutting area is within an area of the sheet of material supported, in use, by the conveyor belt.

11. A laser cutting machine according to claim 6, wherein the material advancing mechanism comprises a conveyor belt and wherein the cutting area and the reading area are within an area of the sheet of material supported, in use, by the conveyor belt.

12. A laser cutting machine according to claim 10, comprising a vacuum mechanism for drawing the sheet of material into contact with the conveyor belt in the cutting area and, if present, the reading area.

13. A laser cutting machine according to claim 1, wherein the laser cutting machine comprises or is couplable to a printer for printing printed matter onto the sheet of material.

14. A laser cutting machine according to claim 13, in which the printer comprises a material-advancing mechanism for advancing the sheet of material through the same incremental advance distance as the laser cutting machine.

15. A laser cutting machine according to claim 13, in which the same material-advancing mechanism advances the sheet of material through the printer and the laser cutting machine.

16. A method for cutting a sheet of material comprising the steps of:
incrementally advancing the sheet of material in a longitudinal direction such that successive laterally-extending portions of the sheet of material are positioned and held stationary at a predetermined cutting position within a laterally-extending cutting area; and
traversing a laser scanner in a lateral direction to cut each laterally-extending portion of the material, while held stationary, by controlling the laser scanner to direct a laser beam within the cutting area in accordance with a cutting pattern; and
repeating these steps to cut the successive laterally-extending portions of the material.

17. A method according to claim 16, wherein the laterally-extending portions of the sheet of material have a longitudinal dimension less than a longitudinal dimension of the cutting area.

18. A method according to claim 16, for cutting the sheet of material according to a predetermined cutting pattern, wherein a dimension of the cutting pattern in the longitudinal direction is greater than a dimension of the cutting area in the longitudinal direction.

19. A method according to claim 16, comprising a step of reading printed matter printed onto the sheet of material, in which the printed matter is preferably selected from a printed cutting pattern, a registration mark or a printed image.

20. A method according to claim 19, wherein the reader is coupled to the laser scanner and comprising the step of reading a portion of the printed matter printed on the laterally-extending portion of the sheet of material held stationary in the predetermined cutting position.

21. A method according to claim 19, wherein the reader is coupled to the laser scanner and comprising the step of reading a portion of the printed matter printed on a laterally-extending portion of the sheet of material adjacent to the laterally-extending portion of the sheet of material held stationary in the predetermined cutting position.

22. A method according to claim 16, wherein the material advancing mechanism comprises a conveyor belt and in which the sheet of material is supported by the conveyor belt during cutting.

23. A method according to claim 19, wherein the material advancing mechanism comprises a conveyor belt and in which the cutting area and the reading area are supported by the conveyor belt during reading and cutting.

24. A method according to claim 16, in which printed matter is printed on the sheet of material by a printer, and the sheet of material output by the printer advances directly to be cut as defined in claim 16.

25. A laser cutting machine according to claim 11, comprising a vacuum mechanism for drawing the sheet of material into contact with the conveyor belt in the cutting area and, if present, the reading area.
